(19) United States
(12) Patent Application Publication
(10) Pub. No.: US 2011/0310369 A1
(43) Pub. Date: Dec. 22, 2011

(54) LITHOGRAPHIC METHOD AND APPARATUS

(75) Inventors: Uwe MICKAN, Veldhoven (NL); Anton Bernhard VAN OOSTEN, Lommel (BE)

(73) Assignee: ASML NETHERLANDS B.V., Veldhoven (NL)

(21) Appl. No.: 13/013,662

(22) Filed: Jan. 25, 2011

Related U.S. Application Data
(60) Provisional application No. 61/302,603, filed on Feb. 9, 2010.

(51) Int. Cl. G03B 27/42

(52) U.S. Cl. 355/53

(57) ABSTRACT

A lithographic method for irradiating resist on a substrate, the resist filling a region located between a first element located on the substrate, and a second element located on the substrate, the first element having a first length, a first width, and a first height, the second element having a second length, a second width, and a second height, the first height being substantially equal to the second height, the first length being substantially parallel to the second length, and extending in a first direction, a distance between facing sidewalls of the first element and the second element that defines the region filled with resist being less than a wavelength of radiation used to irradiate the resist, the method including irradiating the resist with elliptically polarized radiation, the elliptically polarized radiation being configured such that, at the first height and second height, the elliptically polarized radiation is polarized perpendicular to the first direction, substantially perpendicular to the first and second lengths.

### CROSS REFERENCE TO RELATED APPLICATIONS

This application claims priority and benefit under 35 U.S.C. §119(e) to U.S. Provisional Patent Application No. 61/302,603, entitled “Lithographic Method and Apparatus”, filed on Feb. 9, 2010. The content of that application is incorporated herein in its entirety by reference.

### FIELD

The present invention relates to a lithographic method and apparatus.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. including part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

Lithographic methods and apparatus may be used to create a wide range of different structures. Some of such structures have dimensions which present challenges that need to be overcome. For example, new transistor designs such as those for FinFETs are characterized by steep structure topographies. For instance, the height difference between structural elements of the FinFET may be up to, for instance, 150 nm. Furthermore, such structures may be or include elements that are separated by a distance which is smaller than a wavelength of radiation used to, for example, irradiate resist located in regions between those elements.

Such steep topographies and/or such small spacing between elements may make it difficult to sufficiently irradiate resist located between the elements. If the resist is not sufficiently irradiated, some resist may not be removed during a subsequent development step. This may cause one or more problems during subsequent processing of the structure or elements of that structure. These dimensions and or topographies may also lead to the establishment of a standing wave in regions between elements, which can lead to regions where, during irradiation, the radiation intensity is zero. This further increases the chances of resist not being sufficiently irradiated and removed during subsequent development. The standing wave problem may additionally or alternatively be present when structures or elements of those structures are located on a layer of material provided on a substrate, the layer of material being at least partly transparent to the radiation used to irradiate the resist. This is because the radiation may be reflected off an interface between the layer of the material and a substrate on which the layer is provide, resulting in the creation of the standing wave. A BARC (bottom anti-reflective coating) on the substrate may eliminate or reduce the intensity of the standing wave, but the BARC can only be used to eliminate or reduce the intensity of the standing wave associated with structures of a single, common, height, and would not be effective for more complex structures in which the constituent elements have different heights (and thus different standing waves). Furthermore, the use of a BARC may conflict with, for example, an implant process used in the manufacture of a device or the like.

### SUMMARY

It is desirable to provide, for example a lithographic method and/or apparatus that obviates or mitigates one or more of the problems of the prior art, whether identified herein or elsewhere, or which provides an alternative to an existing lithographic method and/or apparatus.

According to a first aspect of the invention, there is provided a lithographic method for irradiating resist on a substrate, the resist filling a region located between a first element located on the substrate, and a second element located on the substrate, the first element having a first length, a first width, and a first height, the second element having a second length, a second width, and a second height, the first height being substantially equal to the second height, the first length being substantially parallel to the second length, and extending in a first direction, a distance between facing sidewalls of the first element and the second element that defines the region filled with resist being less than a wavelength of radiation used to irradiate the resist, the method including: irradiating the resist with elliptically polarized radiation, the elliptically polarized radiation being configured such that, at the first height and second height, the elliptically polarized radiation is polarized perpendicular to the first direction, substantially perpendicular to the first and second lengths.

The resist may also fill a further region located between a third element located on the substrate, and a fourth element located on the substrate, the third and fourth elements being located between the first and second elements, the third element having a third length, a third width, and a third height, the fourth element having a fourth length, a fourth width, and a fourth height, the third height being substantially equal to the fourth height, and the third and fourth heights being lower than the first and second heights, the third length being substantially parallel to the fourth length, and extending in a second direction, a distance between facing sidewalls of the third element and the fourth element that defines the further region filled with resist being less than a wavelength of radiation used to irradiate the resist, and the method may include: substantially simultaneously irradiating the resist in the further region with elliptically polarized radiation, the elliptically polarized radiation being configured such that, at the first height and second height, the elliptically polarized radiation is polarized in a first direction substantially perpendicular to the first and second lengths, and at the third height and fourth height, the elliptically polarized radiation is polarized perpendicular to the second direction, substantially perpendicular to the third and fourth lengths. ‘Substantially simultaneously’ may be interpreted as being during the same irradiation process of the resist in the region between the first and second elements, a very minor time difference being involved due to the lower heights of the third and fourth elements.

The polarization direction may change over the distance between the first height and the second height (i.e. between the different heights of the elements), and the third height and the fourth height, from perpendicular to the first direction, to perpendicular to the second direction.

The second direction may be substantially perpendicular to the first direction (or be at a different orientation, or be in the same direction).

The third and fourth elements may extend (at least partially) between the first and second elements.

The third and fourth elements may be, or may be used to form (e.g. after further processing), fins of a FINFET transistor.

The first and second elements may be, or may be used to form (e.g. after further processing), gates of a transistor.

The first and second elements, and/or the third and fourth elements may be located on a layer provided on the substrate that is substantially transparent to the radiation, and the substrate may be substantially opaque to that radiation.

A layer provided on the substrate may include of SiO₂, and/or the substrate may include of Si.

The resist may also at least partially cover the first and second elements, and the method may include, substantially simultaneously with irradiating resist in the region between the first and second elements, irradiating at least a part of the resist covering the first and second elements.

The first element may be substantially the same size and shape as the second element, and/or the third element may be substantially the same size and shape as the fourth element.

The irradiation may be undertaken without first providing on the substrate a BARC, since a BARC may not be required in accordance with embodiments of the present invention (as discussed in more detail below).

According to a second aspect of the invention, there is provided a device, or a part of a device, manufactured using the method of the first aspect of the invention.

According to a third aspect of the invention, there is provided a lithographic apparatus a lithographic apparatus including: an illumination system configured to provide a radiation beam; a patterning device configured to impart the radiation beam with a pattern in its cross-section; a substrate holder configured to hold a substrate, the substrate, in use, carrying resist, the resist filling a region located between a first element located on the substrate, and a second element located on the substrate, the first element having a first length, a first width, and a first height, the second element having a second length, a second width, and a second height, the first height being substantially equal to the second height, the first length being substantially parallel to the second length, and extending in a first direction, a distance between facing sidewalls of the first element and the second element that defines the region filled with resist being less than a wavelength of radiation used to irradiate the resist; a projection system configured to project the patterned radiation beam onto a target portion of the substrate, an elliptical polarization arrangement (e.g. including a phase locking element), for ensuring that the radiation is, in use, elliptically polarized when projected onto the substrate and configured such that, at the first height and second height, the elliptically polarized radiation is polarized perpendicular to the first direction, substantially perpendicular to the first and second lengths.

The elliptical polarization arrangement may be configured or controllable to carry out any one or more parts of the method of the first aspect of the invention.

The elliptical polarization arrangement may include one or more exchangeable parts or tunable parts, for use in ensuring that the radiation has a desired polarization state at a desired height.

The elliptical polarization arrangement may include, or may be in connection with, or may be usable in conjunction with, a polarization sensor located adjacent to, or forming a part of, a focus calibration sensor at a substrate plane (i.e. an image plane).

The elliptical polarization arrangement may include one or more elements that are adjustable along the optical axis of the lithographic apparatus for shifting a polarization state or polarization direction with respect to a focal region, plane or point of the lithographic apparatus.

### BRIEF DESCRIPTION OF THE DRAWINGS

Embodiments of the invention will now be described, by way of example only, with reference to the accompanying schematic Figures in which corresponding reference symbols indicate corresponding parts, and in which:

FIG. 1 schematically depicts an example of a lithographic apparatus;

FIG. 2 schematically depicts a side-on view of a structure provided on a substrate;

FIG. 3 schematically depicts a plan view of the structure of FIG. 2;

FIG. 4 schematically depicts in side-on view the structure of FIGS. 2 and 3 when covered with resist;

FIG. 5 schematically depicts the structure and resist of FIG. 4, together with the irradiation of a part of that resist and structure;

FIG. 6 schematically depicts a simplified plan view of the structure of FIG. 5, further depicting the polarization direction of radiation at different heights of different elements forming the structure; and

FIG. 7 schematically depicts a side-on view of a part of the structure and a part of the resist after the irradiation shown in FIG. 6, and subsequent development.

### DETAILED DESCRIPTION

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of a patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected. beam is patterned.

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The illumination system may also encompass various types of optical components, including refractive, reflective, and catadioptric optical components to direct, shape, or control the beam of radiation, and such components may also be referred to below, collectively or singularly, as a “lens”.

The lithographic apparatus may be of a type having two (dual stage) or more substrate holders (and/or two or more support structures). In such “multiple stage” machines the additional holders may be used in parallel, or preparatory steps may be carried out on one or more holders while one or more other holders are being used for exposure.

The lithographic apparatus may also be of a type wherein the substrate is immersed in a liquid having a relatively high refractive index, e.g. water, so as to fill a space between the final element of the projection system and the substrate. Immersion techniques are well known in the art for increasing the numerical aperture of projection systems.

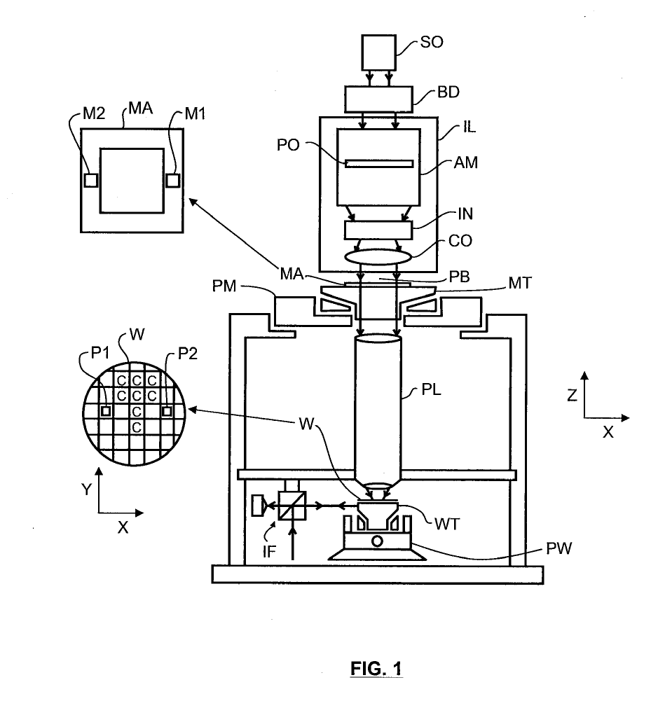

FIG. 1 schematically depicts an example of a lithographic apparatus. The apparatus includes:

an illumination system (illuminator) IL to condition a beam PB of radiation (e.g. UV radiation or EUV radiation).

a patterning device support or support structure (e.g. a mask table) MT to support a patterning device (e.g. a mask) MA and connected to first positioning device PM to accurately position the patterning device with respect to item PL;

a substrate holder (e.g. a wafer table) WT configured to hold a substrate (e.g. a resist-coated wafer) W and connected to second positioning device PW for accurately positioning the substrate with respect to item PL; and

a projection system (e.g. a refractive projection lens) PL configured to image a pattern imparted to the radiation beam PB by patterning device MA onto a target portion C (e.g. including one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including for example suitable directing minors and/or a beam expander—i.e. the radiation source SO may be in connection with the lithographic apparatus. In other cases the source may be integral part of the apparatus, for example when the source is a mercury lamp. The source SO and the illuminator IL, together with the beam delivery system BD if required, may be referred to as a radiation system.

The illuminator IL may include an adjusting device AM configured to adjust the angular intensity distribution of the beam. Generally, at least the outer and/or inner radial extent (commonly referred to as a-outer and a-inner, respectively) of the intensity distribution in a pupil plane of the illuminator can be adjusted. In addition, the illuminator IL generally includes various other components, such as an integrator IN and a condenser CO. The illuminator provides a conditioned beam of radiation PB, having a desired uniformity and intensity distribution in its cross-section. The illuminator IL is also provided with an elliptical polarization arrangement PO (which can be broadly termed an “elliptical polarizer”) for ensuring that radiation that is projected onto the substrate is elliptically polarized, as discussed in more detail below. The elliptical polarization arrangement or polarizer PO may form part of the illuminator IL, and for example may form part of the adjusting device AM of the illuminator IL. In other embodiments, the elliptical polarization arrangement or polarizer may be located at any appropriate location in the path of the radiation beam as it traverses the lithographic apparatus, and may be located outside of the illuminator IL.

The radiation beam PB is incident on the patterning device (e.g. mask) MA, which is held on the patterning device support MT. Having traversed the patterning device MA, the beam PB passes through the projection system PL, which focuses the beam onto a target portion C of the substrate W. With the aid of the second positioning device PW and position sensor IF (e.g. an interferometric device), the substrate holder WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables/holders MT and WT will be realized with the aid of a long-stroke module (coarse positioning) and a short-stroke module (fine positioning), which form part of the positioning device PM and PW. However, in the case of a stepper (as opposed to a scanner) the patterning device support MT may be connected to a short stroke actuator only, or may be fixed. Patterning device MA and substrate W may be aligned using patterning device alignment marks M1, M2 and substrate alignment marks P1, P2.

The depicted apparatus can be used in the following preferred modes:
1. In step mode, the patterning device support MT and the substrate holder WT are kept essentially stationary, while an entire pattern imparted to the beam PB is projected onto a target portion C in one go (i.e. a single static exposure). The substrate holder WT is then shifted in the X and/or Y direction so that a different target portion C can be exposed. In step mode, the maximum size of the exposure field limits the size of the target portion C imaged in a single static exposure.
2. In scan mode, the patterning device support MT and the substrate holder WT are scanned synchronously while a pattern imparted to the beam PB is projected onto a target portion C (i.e. a single dynamic exposure). The velocity and direction of the substrate holder WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.
3. In another mode, the patterning device support MT is kept essentially stationary holding a programmable patterning device, and the substrate holder WT is moved or scanned while a pattern imparted to the beam PB is projected onto a target portion C. In this mode, generally a pulsed radiation source is employed and the programmable patterning device is updated as required after each movement of the substrate holder WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

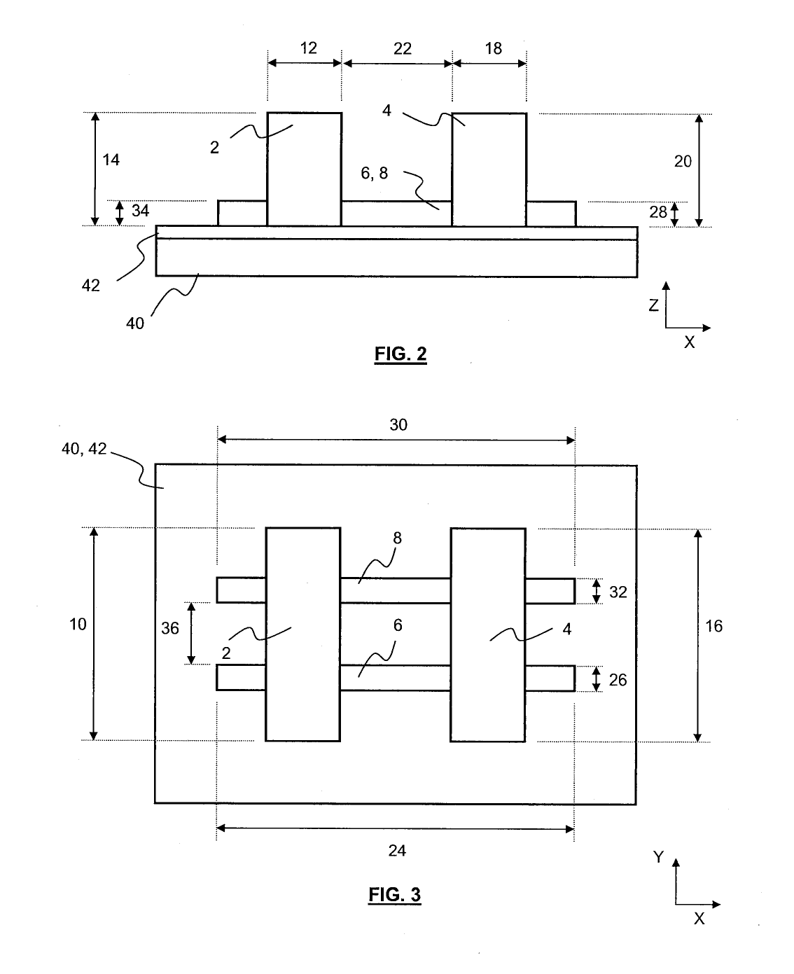

FIG. 2 schematically depicts a side-on view, and FIG. 3 a plan view, of a structure provided on a substrate. FIGS. 2 and 3 will be referred to in combination. The structure includes of four elements: a first element 2, a second element 4, a third element 6 and a fourth element 8. The first element 2 has a first length 10, a first width 12, and a first height 14. The second element 4 is substantially the same size and shape of the first element 2. The second element 4 has a second length 16, a second width 18, and a second height 20.

The first length 10 is substantially parallel to the second length 16, the first length 10 and second length 16 extending in a first direction (i.e. in the Y direction in this embodiment). A distance 22 between facing side walls of the first element 2 and second element 4 defines a region that will subsequently be filled with resist. This distance 22 is less than a wavelength of radiation used to subsequently irradiate that resist (e.g. 100 nm or less).

Also provided on the substrate, as discussed above, are a third element 6 and a fourth element 8. The third element 6 has a third length 24, a third width 26, and a third height 28. The fourth element 8 is substantially the same size and shape of the third element 6. The fourth element 8 has a fourth length 30, a fourth width 32, and a fourth height 34.

The third length 24 is substantially parallel to the second length 30, the third length 24 and second length 30 extending in a second direction (i.e. in the X direction in this embodiment) that is substantially perpendicular to the first direction in which the first element 2 and second element 4 extend in a lengthwise manner. A distance 36 between facing side walls of the third element 6 and fourth element 8 defines a region that will subsequently be filled with resist. This distance 36 is less than a wavelength of radiation used to subsequently irradiate that resist (e.g. 100 nm or less).

It will be appreciated that the first element 2 and second element 4 extend lengthwise in a direction substantially perpendicular to the lengthwise extension of the third element 6 and fourth element 8. Furthermore, the third element 6 and fourth element 8 extend at least partly between the first element 2 and second element 4 such that the third element 6 and fourth element 8 are located at least partially between the first element 2 and second element 4. The third element 6 and fourth element 8 may form, or subsequently form, fins of a FinFET transistor or the like. The first element 2 and second element 4 may form, or subsequently form, gates of a transistor (e.g. a FinFET transistor).

The structure as a whole is located on a substrate 40 (for example, the substrate described above in relation to FIG. 1), and may be provided using known lithographic techniques (optical or imprint based). The substrate 40 is provided with a layer of material 42, so that the structure as a whole is located on that layer of material 42. The layer of material 42 may be useful in the formation of the structure, or during subsequent processing of the structure. The layer of material 42 may (intentionally or unintentionally) be substantially transparent to the radiation subsequently used to irradiate resist provided on the substrate 40. The substrate 40 may (intentionally or unintentionally) be substantially opaque to that radiation. The layer 42 may be formed, for example, from SiO₂. The substrate may be or include Si.

The widths, lengths and heights of the first, second, third and/or fourth elements may be design dependent (e.g. related to the device of which the element form, or will form, a part). For example, the widths, lengths and heights of the first, second, third and/or fourth elements may be of the order of nanometers, for example 100 nm or less.

When elements of a structure (e.g. first and second elements, or third and fourth elements) are separated by a distance that is less than a wavelength subsequently used to irradiate resist located between those elements, it has been found that problems may be encountered when attempting to adequately irradiate that resist, and subsequently remove the irradiated resist.

FIG. 4 shows the structure of FIGS. 2 and 3, but now with resist 50 covering the elements 2, 4, 6, 8 and filling regions between those elements 2, 4, 6, 8. The resist 50 may be provided in a conventional manner.

According to an embodiment of the present invention, the problems discussed above may be obviated or mitigated. This may be achieved by irradiating a resist-covered structure, similar or identical to that discussed above, with elliptically polarized radiation. With reference to the structure described previously, the elliptically polarized radiation is configured such that, at the first height of the first element and second height of the second element (which are substantially the same), the elliptically polarized radiation is polarized in a direction (i.e. a first direction) substantially perpendicular to the first length of the first element and second length of the second element (both lengths extending in the same direction). In other words, the polarization direction is parallel to the distance extending perpendicularly between facing sidewalls of the (parallel extending) elements. When the radiation used to irradiate the resist is polarized in this manner, the radiation may readily irradiate the resist located in the region between facing side walls of the first element and the second element. Alternatively or additionally, the polarization in this direction may result in a disturbance or the prevention of the formation of any standing wave. The resist in the region between the first and second elements may thus be more readily and uniformly irradiated, allowing a more thorough removal of the resist from that region in a subsequent development process. Furthermore, no BARC needs to be provided prior to the irradiation in order to eliminate or reduce the intensity of the standing wave. This may reduce manufacturing cost and/or complexity.

If third and fourth elements are also present (as in the structure defined above) the elliptically polarized radiation may be configured such that, at the third height of the third element and fourth height of the fourth element (which are substantially the same as each other, but different to the height of the first and second elements), the elliptically polarized radiation is polarized in a direction (i.e. a second direction) substantially perpendicular to the third length of the third element and fourth length of the fourth element (both lengths extending in the same direction). In other words, the polarization direction is parallel to the distance of the gap between the elements. The polarization direction may be configured to change from the first direction to the second direction as the radiation traverses the difference in heights between the first and second, and third and fourth elements.

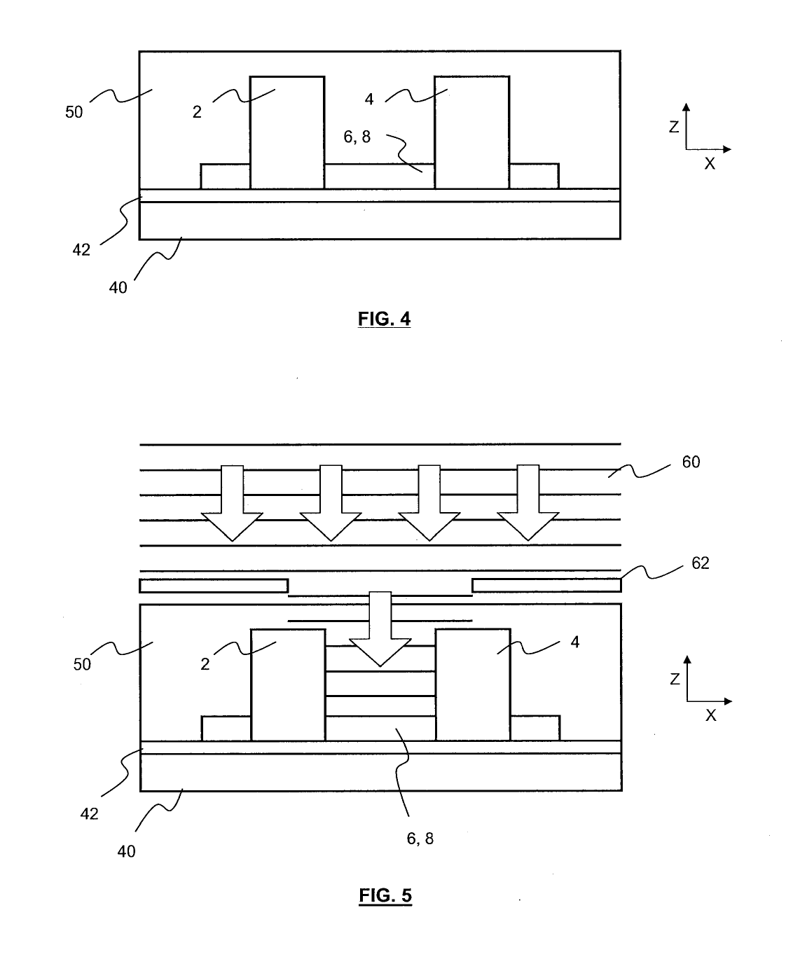

FIG. 5 shows the structure and resist of FIG. 4 when irradiated with radiation. FIG. 5 shows radiation 60 being directed towards a patterning device 62. In this example, the patterning device 62 is a basic transmissive mask, but in other embodiments the patterning device may be more or less complex (in terms of the pattern provided in or to the radiation) and/or may be transmissive or reflective in nature. The patterning device 62 ensures that only certain parts of the structure (i.e. certain elements 2, 4, 6, 8 or parts of those elements 2, 4, 6, 8) and covering resist 50 is irradiated with radiation 60. For instance, certain regions of resist 50 may need to be removed in order to reveal certain parts of certain elements 2, 4, 6, 8, or regions between those elements 2, 4, 6, 8. This may be undertaken, for instance, in order to subsequently undertake an implant process or the like on or in certain elements 2, 4, 6, 8 forming the structure. An implant process might be undertaken in order to, for example, form part of a transistor or the like (e.g. a FinFET transistor). As discussed above, the wavelength of radiation 60 used to irradiate the resist 50 is greater than the distance between the facing side walls of the first element 2 and second element 4.

The radiation 60 is elliptically polarized. The use of elliptical polarization is particularly versatile, since by appropriate tuning of (i.e. configuring of) the polarization using an elliptical polarization arrangement or polarizer (discussed in more detail below), the radiation 60 can be configured to be polarized in a certain direction and at a certain height (e.g. in the Z-direction in the present embodiment), and this polarization direction can also be configured to be in certain different directions, or in the same direction, at different heights for different elements of the structure.

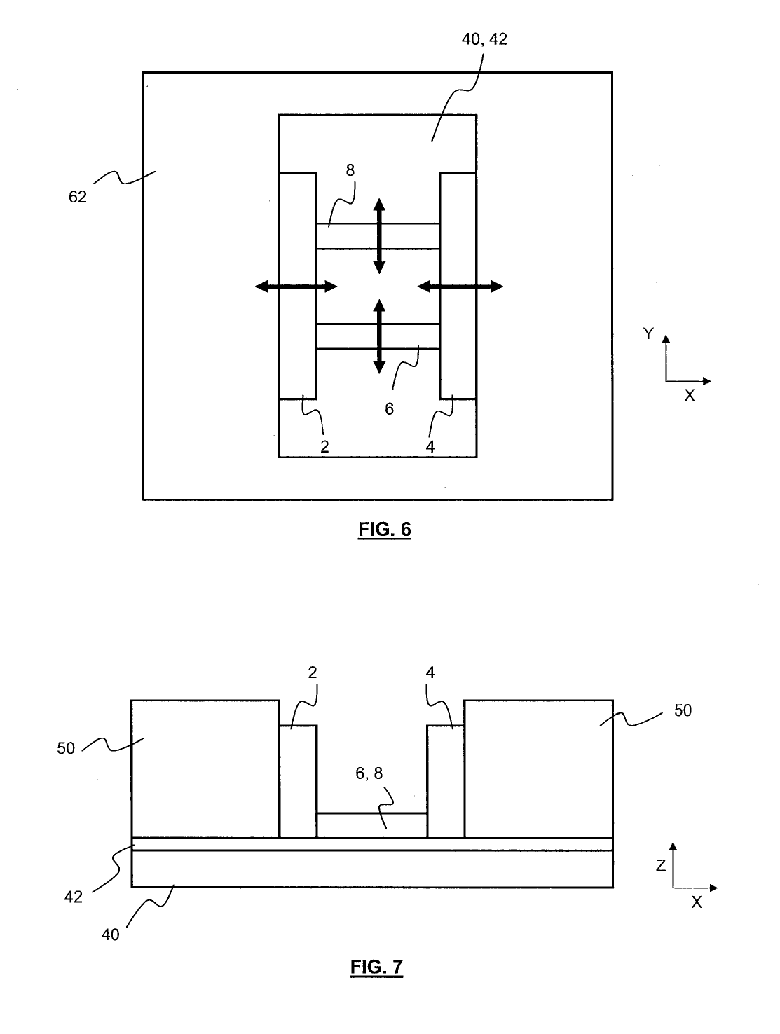

FIG. 6 is a simplified plan view of FIG. 5. The resist has not been shown, in order that the underlying elements 2, 4, 6, 8 of the structure are visible. Arrows in the Figure depict the polarization direction of radiation at the height of each of the elements 2, 4, 6, 8 of the structure. At the height of the first element 2 and second element 4 (which are substantially the same height) the radiation is polarized substantially perpendicular to the lengths of those elements 2, 4 (i.e. in the X-direction in this embodiment, across the gap between those elements). The heights of the third element 6 and fourth element 8 are lower than those heights of the first element 2 and second element 4. The polarization direction of the radiation at the (lower) heights of the third element 6 and fourth element 8 is again in a direction substantially perpendicular to the length of those third and fourth elements 6, 8 (i.e. in the Y-direction in this embodiment, across the gap between those elements). The polarization direction has thus rotated by 90° between the height of the first and second elements 2, 4, and the lower heights of the third and fourth elements 6, 8. This can be ensured by appropriate configuration of the elliptical polarization, as will be appreciated by one skilled in the art of optics, for example by introducing an appropriate phase difference between two orthogonal components of a radiation beam.

Although the polarization direction has been shown as being rotated by 90° in FIG. 6, this is only given as an example. The polarization direction can be confined to be in any particular direction at any particular height, such that in another example the polarization direction may be the same for the different heights, or may be different at different heights but oriented at an angle other than 90° at those different heights.

As discussed above, because the radiation is polarized in a direction substantially perpendicular to the length of the respective elements at the different heights of those elements (i.e. parallel to the widths of those elements, or in other words parallel to the distance between those elements), the radiation may more readily pass into and irradiate resist located in regions between those elements. FIG. 7 shows that, after subsequent development of the resist that has been irradiated, the resist is satisfactorily removed from the regions between the elements. Such removal may be beneficial for subsequent processing of that structure to form a device or the like (e.g. during an implantation step or the like) and/or for operation of a device formed from that structure.

The method described above may be undertaken using the lithographic apparatus as described in relation to FIG. 1. The elliptical polarization arrangement or polarizer described in relation to FIG. 1 may be used to ensure that the radiation is, in use, elliptically polarized when projected onto the substrate and configured such that, at the first height and second height (of the first and second elements) the elliptically polarized radiation is polarized in the first direction substantially perpendicular to the first and second lengths of those elements. If third and fourth elements are present, the elliptical polarization arrangement or polarizer may be configured to further ensure that the radiation is, in use, configured such that at the third height and fourth height (of the third and fourth elements) the elliptically polarized radiation is polarized in a direction substantially perpendicular to the third and fourth lengths of the third and fourth elements.

The elliptical polarization arrangement or polarizer may typically be or include a λ/4 device with a thickness that is related to the height difference between the first and second elements (which is substantially the same), and the third and fourth elements (which is substantially the same and lower in height than the first and second elements), thereby ensuring that the radiation is polarized as desired in the required directions at the different heights. A phase locking device or element may form part of the elliptical polarization arrangement or polarizer to ensure that a relative phase between two orthogonal components of the radiation is sufficient to ensure that the polarization direction has a certain desired direction at the different, required, heights for different structures on the substrate.

The elliptical polarization arrangement or polarizer may include one or more exchangeable parts or tunable parts (for example have a part having a tunable thickness, or a part exchangeable for a part with a different thickness, such as tunable or exchangeable polarizers) to be able to ensure that the radiation has a desired polarization state (e.g. linearly polarized in a certain direction) at a desired height (e.g. the height of the first and second elements, and/or at the height of the third and fourth elements, discussed above). The elliptical polarization arrangement or polarizer may include one or more exchangeable parts or tunable parts (for example have a part having a tunable thickness, or a part exchangeable for a part with a different thickness, such as tunable or exchangeable polarizers) to be able to apply the inventive method to different structures that may have elements with different heights.

The elliptical polarization arrangement or polarizer may include one or more elements which are adjustable along the optical axis of the lithographic apparatus (e.g. in terms of position, or extension, or size, or the like), so that the different polarization states or directions may be shifted with respect to a focal region, plane or point of the lithographic apparatus. The polarization arrangement or polarizer may include, or be used in conjunction with (e.g. be in connection with) a polarization sensor located adjacent to (or forming a part of) a focus calibration sensor at the substrate plane (sometimes referred to as the image plane). The polarization sensor may be used to provide feedback to the polarization arrangement or polarizer so that the polarization state and focus may be accurately configured (e.g. aligned) with respect to, or relative to, one another.

In the above embodiment, the radiation has been described as being polarized in direction substantially perpendicular to the length of those elements. This may alternatively or additionally be described as the radiation being polarized in a direction substantially parallel to the widths of those elements, or parallel to a distance extending perpendicularly from a sidewall of an element to the facing sidewall of a parallel element.

Embodiments of the invention are not limited to the irradiation of a structure, or elements of that structure, that forms, or will form, a FinFET. The irradiation of any resist covered structure having dimensions as discussed above is intended to be covered by the present invention (e.g. other transistor designs).

While specific embodiments of the invention have been described above, it will be appreciated that the invention may be practiced otherwise than as described. The description is not intended to limit the invention, the invention instead being limited by the claims that follow.

1. A lithographic method for irradiating resist on a substrate,
the resist filling a region located between a first element located on the substrate, and a second element located on the substrate,
the first element having a first length, a first width, and a first height,
the second element having a second length, a second width, and a second height,
the first height being substantially equal to the second height,
the first length being substantially parallel to the second length, and extending in a first direction,
a distance between facing sidewalls of the first element and the second element that defines the region filled with resist being less than a wavelength of radiation used to irradiate the resist,
the method comprising:
irradiating the resist with elliptically polarized radiation, the elliptically polarized radiation being configured such that, at the first height and second height, the elliptically polarized radiation is polarized perpendicular to the first direction, substantially perpendicular to the first and second lengths.

2. The method of claim 1, wherein the resist also fills a further region located between a third element located on the substrate, and a fourth element located on the substrate, the third and fourth elements being located between the first and second elements,
the third element having a third length, a third width, and a third height,
the fourth element having a fourth length, a fourth width, and a fourth height,
the third height being substantially equal to the fourth height, and the third and fourth heights being lower than the first and second heights,
the third length being substantially parallel to the fourth length, and extending in a second direction,
a distance between facing sidewalls of the third element and the fourth element that defines the further region filled with resist being less than a wavelength of radiation used to irradiate the resist,
the method comprising:
substantially simultaneously irradiating the resist in the further region with elliptically polarized radiation, the elliptically polarized radiation being configured such that, at the first height and second height, the elliptically polarized radiation is polarized in a first direction substantially perpendicular to the first and second lengths, and at the third height and fourth height, the elliptically polarized radiation is polarized perpendicular to the second direction, substantially perpendicular to the third and fourth lengths.

3. The method of claim 2, wherein the polarization direction changes over the distance between the first height and the second height, and the third height and the fourth height, from perpendicular to the first direction, to perpendicular to the second direction.

4. The method of claim 2, wherein the second direction is substantially perpendicular to the first direction.

5. The method of claim 2, wherein the third and fourth elements extend between the first and second elements.

6. The method of claim 2, wherein the third and fourth elements are, or will be, fins of a FINFET transistor.

7. The method of claim 1, wherein the first and second elements are, or will be, gates of a transistor.

8. The method of claim 2, wherein the first and second elements, and/or the third and fourth elements are located on a layer provided on the substrate that is substantially transparent to the radiation, and the substrate is substantially opaque to that radiation.

9. The method of claim 8, wherein the layer comprises of SiO₂, and/or the substrate comprises of Si.

10. The method of claim 1, wherein the resist also at least partially covers the first and second elements, and the method comprises, substantially simultaneously with irradiating resist in the region between the first and second elements, irradiating at least a part of the resist covering the first and second elements.

11. The method of claim 1, wherein the first element is substantially the same size and shape as the second element, or the third element is substantially the same size and shape as the fourth element, or both.

12. A device, or a part of a device, manufactured using the method of any of the preceding claims.

13. A lithographic apparatus comprising:
an illumination system configured to provide a radiation beam;
a patterning device configured to impart the radiation beam with a pattern in its cross-section to form a patterned radiation beam;
a substrate holder configured to hold a substrate, the substrate, in use, carrying resist, the resist filling a region located between a first element located on the substrate, and a second element located on the substrate, the first element having a first length, a first width, and a first height, the second element having a second length, a second width, and a second height, the first height being substantially equal to the second height, the first length being substantially parallel to the second length, and extending in a first direction, a distance between facing sidewalls of the first element and the second element that defines the region filled with resist being less than a wavelength of radiation used to irradiate the resist;
a projection system configured to project the patterned radiation beam onto a target portion of the substrate,
an elliptical polarizer configured to, in use, elliptically polarize the radiation when projected onto the substrate and configured such that, at the first height and second height, the elliptically polarized radiation is polarized perpendicular to the first direction, substantially perpendicular to the first and second lengths.

14. The apparatus of claim 13, wherein the elliptical polarizer comprises one or more exchangeable parts or tunable parts, for use in ensuring that the radiation has a desired polarization state at a desired height.

15. The apparatus of claim 13, wherein the elliptical polarizer comprises, or is in connection with, or is usable in conjunction with, a polarization sensor located adjacent to, or forming a part of, a focus calibration sensor at a substrate plane.

16. The apparatus of claim 13, wherein the elliptical polarizer comprises one or more elements that are adjustable along the optical axis of the lithographic apparatus for shifting a polarization state or polarization direction with respect to a focal region, plane or point of the lithographic apparatus.
